(19) United States
(12) Patent Application Publication
(10) Pub. No.: US 2020/0382815 A1
(43) Pub. Date: Dec. 3, 2020

(54) SYSTEM AND METHOD FOR FACILITATING LIVE ONLINE EVENTS

(71) Applicant: MeetEm, Inc., Charleston, SC (US)

(72) Inventor: Howard Lee Gatch, III, Charleston, SC (US)

(21) Appl. No.: 16/999,370

(22) Filed: Aug. 21, 2020

Related U.S. Application Data
(63) Continuation-in-part of application No. 16/401,959, filed on May 2, 2019.
(60) Provisional application No. 62/665,989, filed on May 2, 2018.

(51) Int. Cl. H04N 21/2187; H04N 21/258; H04N 21/2543; H04N 21/854; H04N 21/262; H04N 21/61

(52) U.S. Cl. CPC H04N 21/2187; H04N 21/25875; H04N 21/6125; H04N 21/854; H04N 21/262; H04N 21/2543

(57) ABSTRACT

A system and method for facilitating live events through an online platform and user management application. Embodiments of the present disclosure enable a platform and application for connecting celebrities and fans through an online community and enabling celebrities to broadcast live online events and fans to view and participate in such events. System is generally comprised of an event management application, a database, a payment gateway, one or more third party API's, a content delivery network, a communications network a plurality of client devices, and a plurality of user profiles for fans and celebrities.

### CROSS-REFERENCE TO RELATED APPLICATIONS

This application is a continuation-in-part of U.S. application Ser. No. 14/703,981, titled SYSTEM AND METHOD FOR FACILITATING LIVE ONLINE EVENTS, filed May 5, 2015 and hereby incorporated by reference in its entirety herein.

### FIELD

The present disclosure relates to the field of internet-enabled live events; in particular, a system and method for facilitating live events through an online platform and user management application.

### BACKGROUND

A number of prior art solutions exist that enable celebrities or other public figures or influencers to broadcast live videos or events to viewers over the Internet. Being able to restrict, control, and manage the number of users able to participate in such live video broadcasts is desirable, and presents a number of challenges that have yet to be solved by prior art solutions. Through applied effort and ingenuity, Applicant has identified a number of deficiencies with prior art solutions for broadcasting live videos or events to viewers over the Internet. Applicant has developed a solution that is embodiment by the present disclosure, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An aspect of the present disclosure is a system for facilitating live online events comprising an event management application server being configured to execute instructions for a user management module, an event management module, and a plurality of application and business logic commands, the user management module operable to dynamically configure a plurality of fan user profiles and a plurality of celebrity user profiles, the event management module being operable dynamically configure a plurality of live online events; a database operably engaged with the event management application, the database being operable to store a plurality of event management and user management attributes; a video server operably engaged with the event management application; at least one celebrity client device operable to communicate one or more inputs to the event management application and broadcast a live online event; and, at least one fan client device operable to communicate one or more inputs to the event management application and view the live online event via a web or mobile browser.

In some embodiments, the user management module further comprises a plurality of user parameters, the user parameters comprising a plurality of user preferences and one or more permissions for viewing the live online event.

In some embodiments, the event management module further comprises a payment module configured to calculate and remit a payment to a broadcaster user according to one or more participant parameters associated with the live online event.

In some embodiments, the plurality of user preferences comprises preferences for associating two or more broadcaster user profiles with a viewer user profile.

In some embodiments, the event management module further comprises a broadcaster user interface that includes interface elements for creating a live event and configuring a broadcaster calendar.

Another aspect of the present disclosure is a computer-implemented method comprising creating, with an application server, a broadcaster user profile in a social network; creating, with the application server, a viewer user profile in the social network, the viewer user profile comprising one or more content permissions; providing to a broadcaster client device, a first user interface to a broadcaster user associated with the broadcaster user profile, the first user interface comprising a first plurality of workflows comprising a workflow to connect a bank account with the application server to facilitate processing of a payment transaction associated with completion of a live video broadcast over the Internet; a workflow to create a calendar listing for the live video broadcast in the application server; and, a workflow to create a broadcaster schedule in the application server; providing to a viewer client device, a second user interface to a viewer user associated with the viewer user profile comprising a first plurality of interface elements corresponding with a plurality of broadcaster user profiles and a second plurality of interface elements corresponding with a plurality of scheduled live video broadcasts; creating, via the second user interface, at least one booking corresponding to at least one scheduled live video broadcast in the plurality of scheduled live video broadcasts; storing, in an application database, the at least one booking and associating the at least one booking with the viewer user profile in the application database; providing, with an email server operably engaged with the application server, a notification of the at least one booking; providing, with the application server, a third user interface comprising a live video broadcast module to the broadcaster client device and the viewer client device; executing, via the live video broadcast module, the scheduled live video broadcast associated with the booking; creating, in the application database, an entry of the total viewer profiles participating in the scheduled live video broadcast; and, executing, via the application server, a payment transaction associated with the broadcaster user profile.

In some embodiments, the computer-implemented method further comprises updating, with the application server, the viewer user profile according to the one or more profile parameters, the one or more profile parameters comprising permissions for participation in the plurality of scheduled live video broadcasts.

In some embodiments, the computer-implemented method further comprises providing a live video broadcast recommendation to the viewer user profile according to the one or more profile parameters.

In some embodiments, the live video broadcast is a one-to-one broadcast.

In some embodiments, the live video broadcast is a one-to-many broadcast.

Yet another aspect of the present disclosure is a computer-implemented method comprising configuring, with an application server, a plurality of broadcaster user profiles associated with a plurality of broadcaster users; configuring, with the application server, a plurality of viewer user profiles associated with a plurality of viewers, each viewer user profile in the plurality of viewer user profiles comprising one or more content permission; providing, to a plurality of broadcaster client devices being communicably engaged with the application server via an Internet connection, a first user interface comprising interface elements for scheduling a live video broadcast; providing, to a plurality of viewer client devices being communicably engaged with the application server via an Internet connection, a second user interface comprising interface elements for requesting to participate in the live video broadcast; receiving, with the application server, a plurality of requests associated with the plurality of viewer user profiles to participate in the live video broadcast; creating, with the application server, an event reservation associated with the plurality of requests associated with the plurality of viewer user profiles to participate in the live video broadcast; providing, with the application server, a third user interface comprising a live video broadcast module to the plurality of broadcaster client devices and the plurality of viewer client devices; executing, via the live video broadcast module, the live video broadcast; storing, with the application server, viewer statistics associated with the live video broadcast; processing, with the application server, a payment transaction according to the viewer statistics.

In some embodiments, the one or more content permission comprises a maximum number of live video broadcasts that the viewer user profile can access within a specified time frame.

In some embodiments, the computer-implemented method further comprises providing a scheduled live video event broadcast recommendation to the viewer user profile in response to the viewer statistics.

In some embodiments, the computer-implemented method further comprises providing a broadcaster recommendation to the viewer user profile in response to the viewer statistics.

In some embodiments, the computer-implemented method further comprises providing a viewer user profile recommendation to the broadcaster user profile in response to the viewer users statistics.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1A is an illustrative embodiment of a computing device through which one or more aspects of the present disclosure may be implemented;

FIG. 1B is a functional block diagram of system for facilitating live online events, according to an embodiment of the present disclosure;

FIG. 2 is a process flow diagram of a routine for facilitating live online events, according to an embodiment of the present disclosure;

FIG. 3 is a process flow diagram of a routine for facilitating live online events, according to an embodiment of the present disclosure;

FIG. 4 is a process flow diagram of a routine for facilitating live online events, according to an embodiment of the present disclosure;

FIG. 5 is a process flow diagram of a routine for facilitating live online events, according to an embodiment of the present disclosure; and,

FIG. 6 is a process flow diagram of a routine for facilitating live online events, according to an embodiment of the present disclosure.

### DETAILED DESCRIPTION

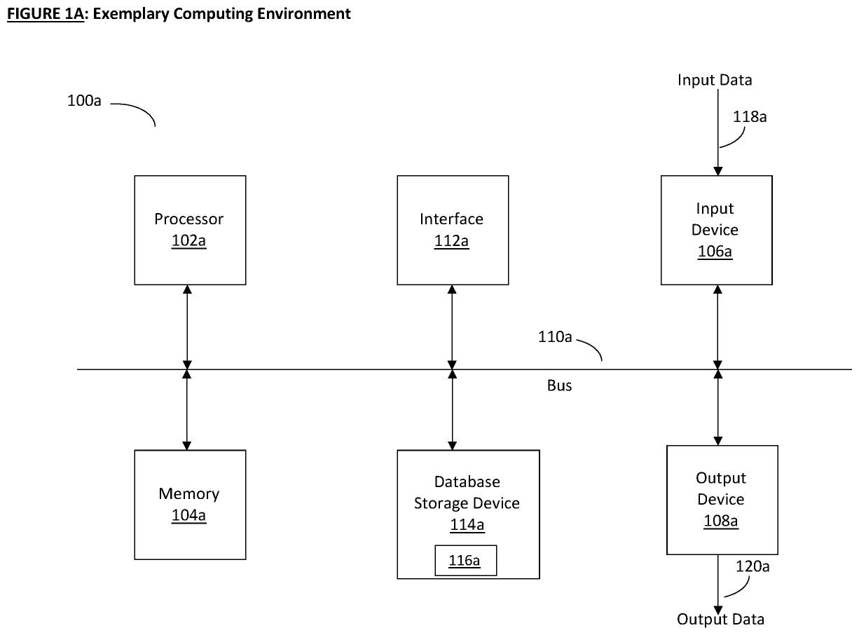

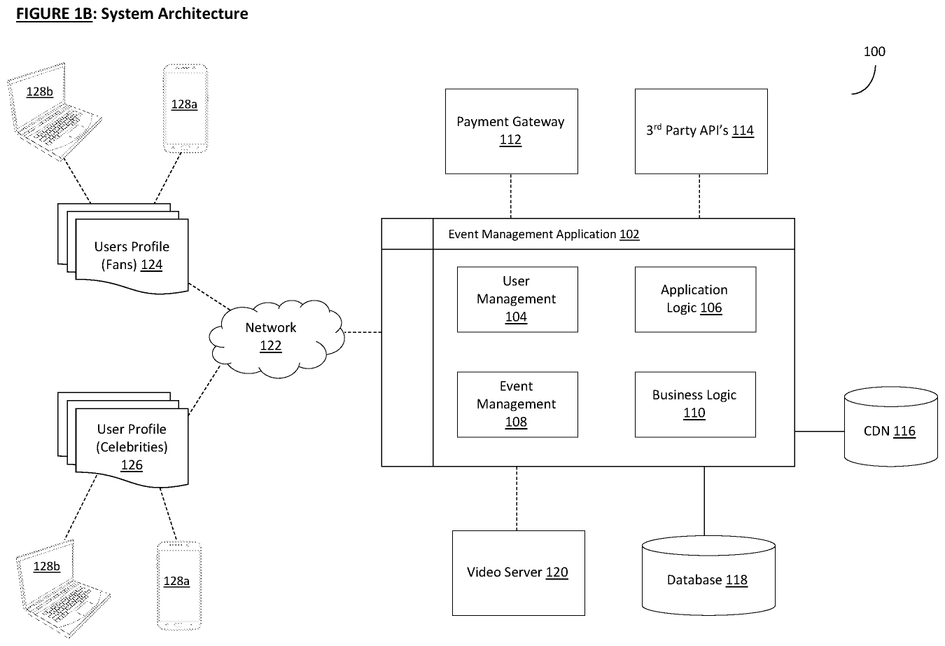

Turning now descriptively to the drawings, in which similar reference characters denote similar elements throughout the several views, FIG. 1A depicts an exemplary general-purpose computing system in which illustrated embodiments of the present invention may be implemented.

A generalized computing embodiment in which the present invention can be realized is depicted in FIG. 1A illustrating a processing system 100a which generally comprises at least one processor 102a, or processing unit or plurality of processors, memory 104a, at least one input device 106a and at least one output device 108a, coupled together via a bus or group of buses 110a. In certain embodiments, input device 106a and output device 108a could be the same device. An interface 112a can also be provided for coupling the processing system 100a to one or more peripheral devices, for example interface 112a could be a PCI card or PC card. At least one storage device 114a which houses at least one database 116a can also be provided. The memory 104a can be any form of memory device, for example, volatile or non-volatile memory, solid state storage devices, magnetic devices, etc. The processor 102a could comprise more than one distinct processing device, for example to handle different functions within the processing system 100a. Input device 106a receives input data 118a and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118a could come from different sources, for example keyboard instructions in conjunction with data received via a network. Output device 108a produces or generates output data 120a and can comprise, for example, a display device or monitor in which case output data 120a is visual, a printer in which case output data 120a is printed, a port for example a USB port, a peripheral component adaptor, a data transmitter or antenna such as a modem or wireless network adaptor, etc. Output data 120a could be distinct and derived from different output devices, for example a visual display on a monitor in conjunction with data transmitted to a network. A user could view data output, or an interpretation of the data output, on, for example, a monitor or using a printer. The storage device 114a can be any form of data or information storage means, for example, volatile or non-volatile memory, solid state storage devices, magnetic devices, etc.

In use, the processing system 100a is adapted to allow data or information to be stored in and/or retrieved from, via wired or wireless communication means, at least one database 116a. The interface 112a may allow wired and/or wireless communication between the processing unit 102a and peripheral components that may serve a specialized purpose. In general, the processor 102a can receive instructions as input data 118a via input device 106a and can display processed results or other output to a user by utilizing output device 108a. More than one input device 106a and/or output device 108a can be provided. It should be appreciated that the processing system 100a may be any form of terminal, server, specialized hardware, or the like.

It is to be appreciated that the processing system 100a may be a part of a networked communications system. Processing system 100a could connect to a network, for example the Internet or a WAN. Input data 118a and output data 120a could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100a illustrated in FIG. 1A may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1A include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100a is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100a, or portions thereof, may be stored in a remote memory storage device. It is to be appreciated that the illustrated network connections of FIG. 1A are exemplary and other means of establishing a communications link between multiple computers may be used.

FIG. 1A is intended to provide a brief, general description of an illustrative and/or suitable exemplary environment in which embodiments of the below described present invention may be implemented. FIG. 1A is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100a of FIG. 1A. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary computing system environment 100 of FIG. 1A being generally shown and discussed above, description will now turn towards illustrated embodiments of the present invention which generally relates to methods for facilitating live events through an online platform and user management application. It is to be understood and appreciated the methods involve establishing a plurality of broadcaster and viewer user profiles in a social network; creating a plurality of scheduled live video broadcasts over a graphical user interface.

Before the present invention and specific exemplary embodiments of the invention are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

Referring now to FIG. 1B, a functional block diagram of system 100 for facilitating live online events is shown. Embodiments of system 100 enable a platform and application for connecting celebrities and fans through an online community, and enabling celebrities to schedule and broadcast live online events and fans to view and participate in such events. According to an embodiment of the present disclosure, system 100 is generally comprised of an event management application 102, a database 118, a payment gateway 112, one or more third party API's 114, a content delivery network (CDN) 116, a communications network 122 a plurality of client devices 128, and a plurality of user profiles for fans 124 and celebrities 126. Event management application 102 is generally comprised of a user management module 104, application logic 106, event management module 108, and business logic 110. User management module 104 is operable to configure and manage a plurality of user profiles for fan users and celebrity users. Event management application 102 is operable to communicate a plurality of attributes for user profiles from user management module 104 to database 118; and, database 118 is operable to store and deliver the plurality of attributes for user management module 104. Event management module 108 is operable to configure a plurality of events associated with a plurality of celebrity user profiles 126 and manage a plurality of event reservations associated with a plurality of fan user profiles 124. Application logic 106 is operable to execute a plurality of commands to enable event management application 102 to be operably engage with payment gateway 112, third party API's 114, CDN 116, and video server 120. Business logic 110 is operable to execute one or more instructions to enable event user application 102 to manage and execute live online events over network 122 to the plurality of client devices 128a and 128b.

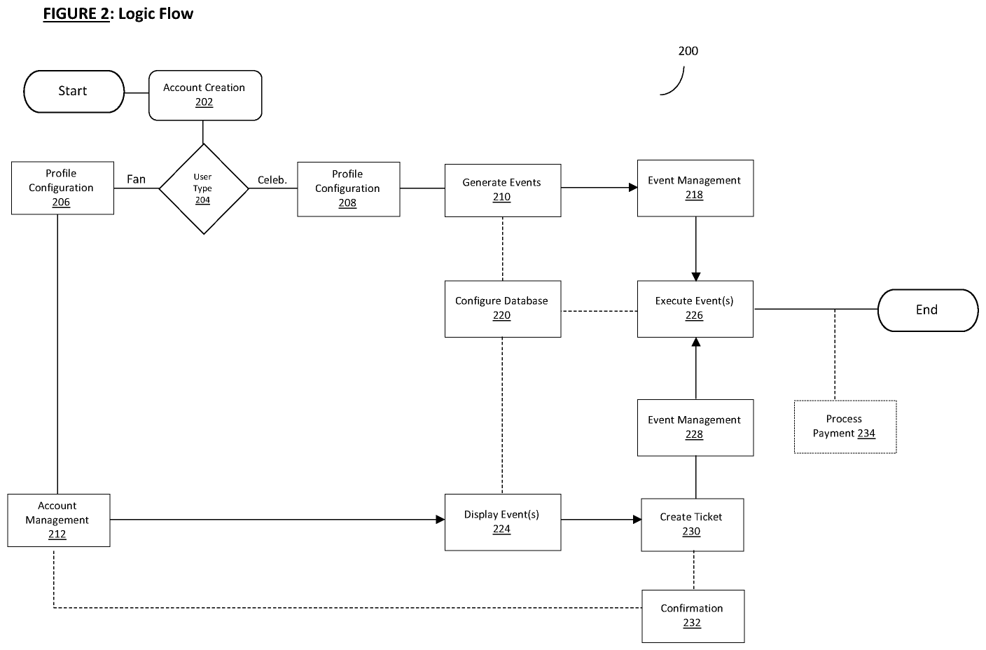

Referring now to FIG. 2, a process flow diagram of a routine 200 for facilitating live online events is shown. According to an embodiment of the present disclosure, a user creates an account 202 via a web or mobile interface. During account creation, the user selects a user type 204 for either a “Fan” user or “Celebrity” user. The terms “fan” and “celebrity” are used in a descriptive or illustrative context, and generally refer to a content consumer or viewer (fan) and a content creator or broadcaster (celebrity). If the user is a fan user, routine 200 proceeds with fan profile configuration 206. During fan profile creation 206, a fan user configures its fan profile to include account identification information and one or more celebrity users that the fan user wants to “like” or follow. If the fan user profile configures a multi-celebrity account, the fan user selects the number of celebrities associated with the multi-celebrity account selection; for example, four celebrities. Continuing with routine 200 from the perspective of the fan user, after profile configuration 206 routine 200 proceeds to account management 212. Account management 212 manages the fan user profile and makes recommendations of celebrity events based on profile configuration and usage statistics of the fan user. Routine 200 displays events 224 to the fan user profile so the fan user profile can view the events via a web or mobile browser to determine the number of events in which the fan user desires to participate.

Continuing with routine 200 from user type decision tree 204, if the user is a celebrity user then routine 200 proceeds with celebrity profile configuration 208. The celebrity user configures the celebrity user profile to include celebrity information and brand and/or copyright assets, types of events the celebrity user will broadcast, and pricing and scheduling information for such events. After inputting the event parameters, routine 200 proceeds with generating the event(s) 210. Once events are generated, the database is configured to store the event attributes 220. Event attributes from the database are displayed to fan users 224, as discussed above, such that users can view and select desired events in which to participate. Once a fan user selects a desired event, routine 200 creates a ticket 230 (i.e. a reservation) for the user to participate in such event at the scheduled date and time. The user receives an event confirmation 232 in the user's account and via email to confirm the user's participation in the event. If the user profile is configured as a multi-celebrity account, routine 200 associates the event confirmation with the event credits associated with the user's account.

Continuing with routine 200, after the celebrity user generates an event 210 and the fan user creates a ticket for an event 230, routine 200 executes an event management module for the celebrity user 218 and an event management module for the fan user 228. Event management 218 enables the celebrity user to view the user's upcoming events, the number of tickets sold for the upcoming event, and one or more analytics associated with the upcoming event (e.g. fan user information and other social media engagement statistics). Event management 228 enables fan users to view the user's upcoming events and pre-event content and media associated with the event. Event management 228 also delivers one or more reminders and pre-event content to keep the fan user engaged and build anticipation for the event. Routine 200 continues by executing the event 226 via a web or mobile interface operably engaged with a video server to enable real-time, two-way video interaction between the celebrity user and the fan users that are participating in the event. Before or upon execution of the event, routine 200 processes a payment 234 from fan users participating in the event, and distributes the funds between the celebrity user broadcasting event and the event management platform.

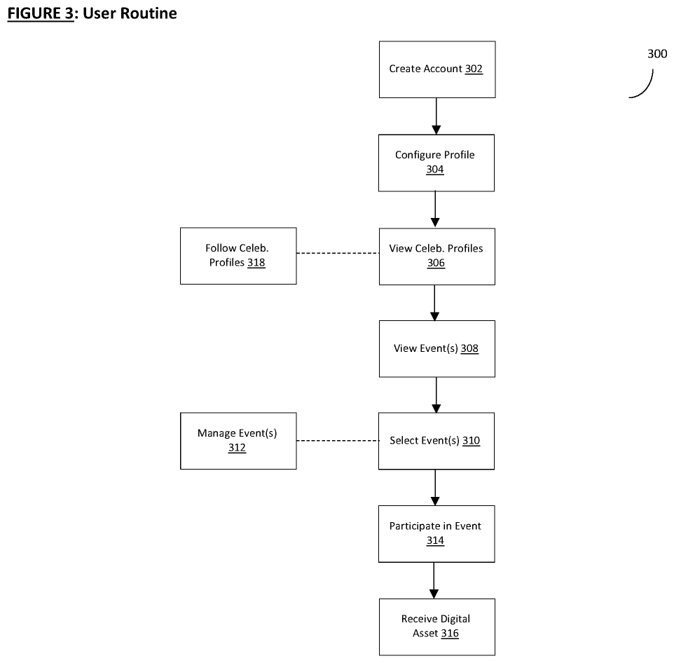

Referring now to FIG. 3, a process flow diagram of a routine 300 for facilitating live online events is shown. According to an embodiment of the present disclosure, routine 300 facilitates the steps taken by a fan user to participate in live online events. Routine 300 is initiated when the fan user navigates to a URL associated with an account creation form and creates an account 302 within the event management application. The fan user then configures his or her profile 304, including account preferences such as subscription type. Once the fan user has created and account and configured his or her profile, the fan user can view celebrity profiles 306 via a web or mobile interface. The fan user can optionally select the celebrity profiles that the fan user desires to follow 318. The fan user may then view one or more events created by celebrity users 308. Events may be suggested to the fan user based on the preferences configured by the user during profile configuration, or the fan user may browse all events in the event management database via a web or mobile interface. The fan user then selects one or more events in which to participate 310. The user's scheduled events are associated with the user's account and managed via the event management application 312. The event management application provides account management by storing and displaying the user's scheduled events in the user's account page, as well as providing updates and reminders associated with the event via email and mobile push notifications. Upon the scheduled date and time of the event, the user participates in the event by connecting to a video server application via a web or mobile interface 314. The video server may be a third-party server that integrates with the event management application to provide a live video and audio experience, or may be integral to the event management application. The live video and audio may be recorded and stored as a digital asset via the video server or the event management database. The fan user may receive the digital asset through the user's account management page 316, and may download and store the digital asset in local storage or share via social media.

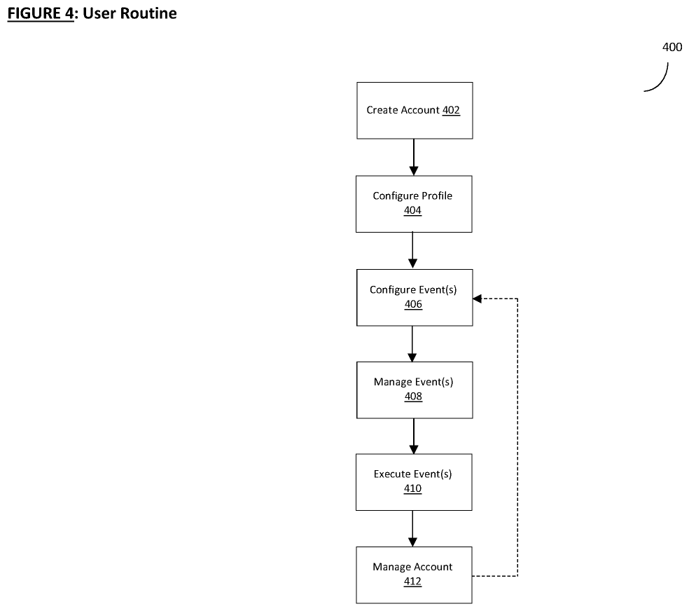

Referring now to FIG. 4, a process flow diagram of a routine 400 for facilitating live online events is shown. According to an embodiment of the present disclosure, routine 400 facilitates the steps taken by a celebrity user to create and facilitate live online events for fans. Routine 400 is initiated when the celebrity user navigates to a URL associated with an account creation form and creates an account 402 within the event management application. The celebrity user then configures his or her profile 404, including profile parameters and digital and/or brand assets associated with the celebrity user. The celebrity user then configures one or more scheduled events associated with the user's account 406; for example, a video group meet and greet, a one-on-one meet and greet, and/or a personalized recorded video message. The celebrity user configures parameters for the event(s) 406, such as event type, date and time, event price, and maximum number of participants. The event is then managed via the event management application 408. The event management application provides event management features in the celebrity user's account, such as schedule reminders and participant data. The event management application may also enable the celebrity user to deliver pre-event content to the participants in order to increase engagement and build anticipation for the event. Upon the scheduled date and time, the celebrity user connects to the video server via a web or mobile interface and executes the event 410. If executing a live event, the celebrity user may interact with fan participants via the video interface and provide dynamic content according to fan feedback. After executing the event, the celebrity user may manage his or her account 412 via an account management interface. The account management interface may enable the celebrity user to view past event information, such as engagement statistics, revenue, and digital assets; as well as configure additional events 406.

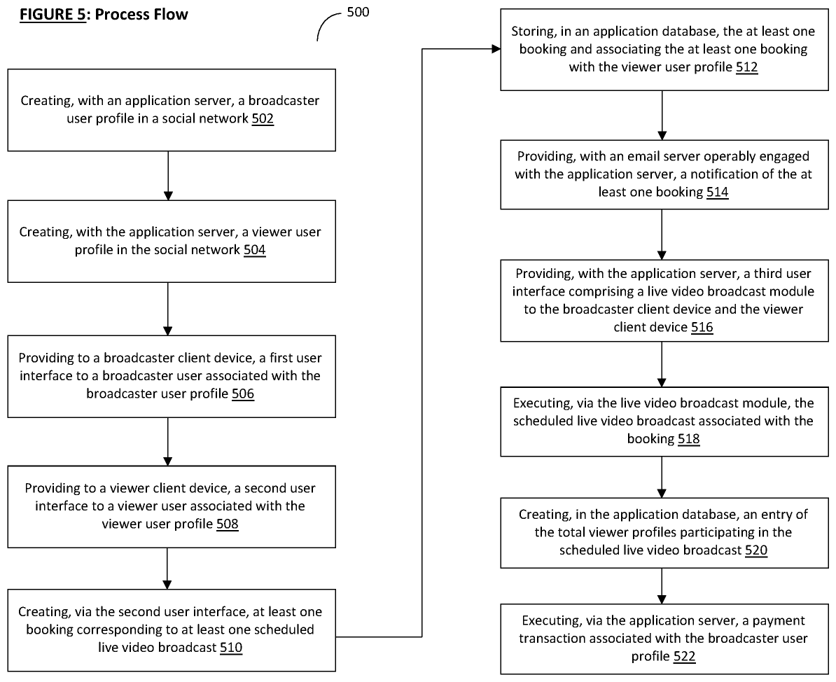

Referring now to FIG. 5, a process flow diagram of a routine 500 for facilitating live online events is shown. According to an embodiment of the present disclosure, routine 500 is initiated by creating, with an application server, a broadcaster user profile in a social network 502. The broadcaster user profile may be associated with a celebrity, sports figure, or other public figure. The social network may comprise a web or mobile application that comprises a plurality of broadcaster users and viewer users. Each broadcaster user and viewer user may have an associated user profile being configured to enable each broadcaster user and viewer user to configure one or more user preferences and create social connections within the social network between a plurality of other broadcaster users and viewer users. Routine 500 continues with creating, with the application server, a viewer user profile in the social network, the viewer user profile comprising one or more profile parameters. The viewer user profile is associated with a viewer user. Viewer users may be commonly associated with “fans” or “followers” of the broadcaster user. The viewer users can find a listing of broadcaster users on the application and “follow” or “friend” the broadcaster users within the social network. The one or more profile parameters may comprise a plurality of user preferences, such as preferred content, preferred genres, user identifying information and other contact information (such as email and social profiles), and subscription details. Subscription details may comprise a plurality of paid or free subscription parameters, including subscription price/level(s), one or more permission(s) to view a specified number of live video broadcasts within a specified timeframe (for example, four live video broadcasts in a month), and the like.

Routine 500 continues with configuring user profiles for the broadcaster user and the viewer user. The broadcaster user profile is configured by providing to a broadcaster client device, a first user interface to a broadcaster user associated with the broadcaster user profile 506. In accordance with an embodiment, the first user interface comprises a first plurality of workflows comprising a workflow to connect a bank account with the application server to facilitate processing of a payment transaction associated with completion of a live video broadcast over the Internet; a workflow to create a calendar listing for the live video broadcast in the application server; and, a workflow to create a broadcaster schedule in the application server. The viewer user profile is configured by providing to a viewer client device, a second user interface to a viewer user associated with the viewer user profile 508. The viewer user may configure the viewer user profile by browsing available broadcasters and scheduled live video broadcasts by viewing and selecting from a first plurality of interface elements corresponding with a plurality of broadcaster user profiles and a second plurality of interface elements corresponding with a plurality of scheduled live video broadcasts.

Routine 500 continues wherein the viewer users create a booking to participate in a scheduled live video broadcast associated with one or more desired broadcaster user. The booking may comprise a request to participate that is subject to approval by the broadcaster user, and/or may comprise a virtual “ticket” to participate in the scheduled live video broadcast. Routine 500 continues by creating, via the second user interface, at least one booking corresponding to at least one scheduled live video broadcast in the plurality of scheduled live video broadcasts. The application server may store, in an application database, the at least one booking and associate the at least one booking with the viewer user profile in the application database 512. The application server may execute one or more reminder notifications corresponding to the scheduled live video broadcast to the viewer user and/or the broadcaster user by providing, with an email server operably engaged with the application server, a notification of the at least one booking 514. The application server may also generate both scheduled and real-time reminders via push notification, SMS text message, automated phone call, email, and the like.

Routine 500 proceeds to enable the provision of the scheduled live video broadcast by providing, with the application server, a third user interface comprising a live video broadcast module to the broadcaster client device and the viewer client device 516. At the scheduled time and upon confirmation by the broadcaster user, the application executes, via the live video broadcast module, the scheduled live video broadcast associated with the booking 518. The live video broadcast module comprises an internal or third-party video player that is contained in the third user interface of the application. The video player is accessible via a web or mobile browser or native mobile application, and enables two-way audio and video transmission via the internal or external video camera and microphones operably engaged with the broadcaster client device and the viewer client device. Upon completion or in real-time with the execution of the scheduled live video broadcast, the application creates, in the application database, an entry of the total viewer profiles participating in the scheduled live video broadcast 618. The application may also track and store other statistics associated with the scheduled live video broadcast, including demographic information, engagement information, viewer-generated comments, social sharing activity, and the like. The application may make this information available to the broadcaster user via one or more dashboards or reports.

Upon completion of the broadcast, routine 500 may continue by executing, via the application server, a payment transaction associated with the broadcaster user profile. The payment transaction may comprise billing a user's credit card or applying a subscription credit against the viewer user's profile. For example, if the user's subscription comprises a total of four credits to participate in live video broadcasts in a one-month period, the application will accordingly update the user's profile to restrict the user's participation to three credits within the remaining subscription period. The payment transaction may also comprise a payment settlement associated with the broadcaster user profile. The payment settlement may occur in real-time with the live scheduled broadcast or at scheduled intervals (for example, bi-weekly). The broadcaster user may be compensated based on the number of viewers who viewed or participated in the live video broadcast. The compensation may also be determined by the type of viewer payment; for example, if the viewer paid $10 to participate in the broadcast, the broadcaster may be compensated $7. Alternatively, if the viewer used a subscription credit to participate in the broadcast, the broadcaster may be compensated a pro rata value of the subscription price against the subscription credit. For example, if a subscription price of $10 entitles the user to 4 broadcast credits, the broadcaster may be compensated some percentage of $2.50 (e.g. $10/4 credits=$2.50/credit). The system may retain a predetermined profit margin (for example, 30%) and settle a transaction to the broadcaster user for the remaining amount of money on a per-viewer, per-broadcast basis.

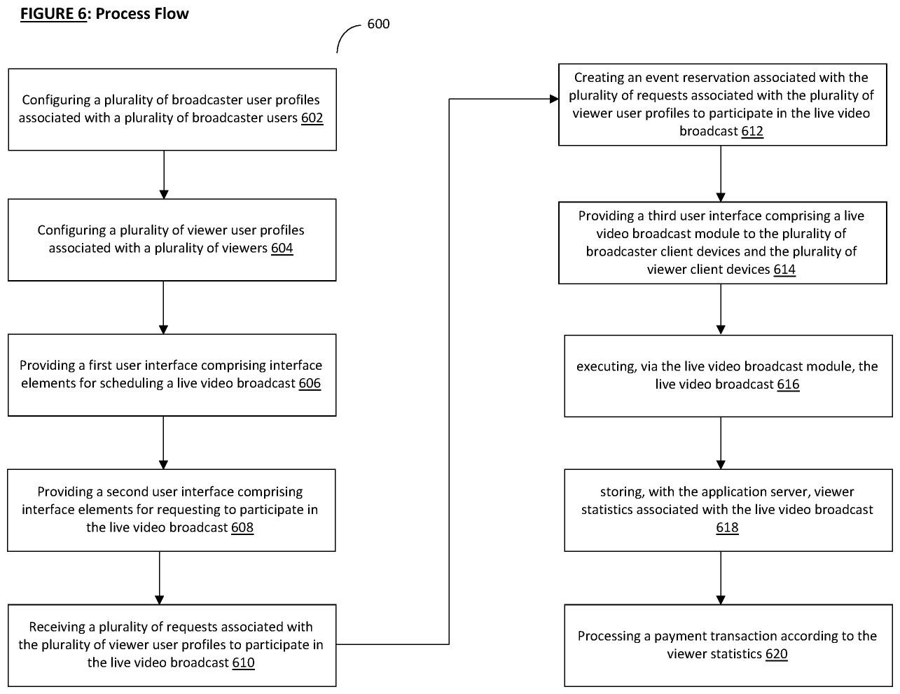

Referring now to FIG. 6, a process flow diagram of a routine 600 for facilitating live online events is shown. According to an embodiment of the present disclosure, routine 600 may be initiated by configuring, with an application server, a plurality of broadcaster user profiles associated with a plurality of broadcaster users 602; and, configuring, with the application server, a plurality of viewer user profiles associated with a plurality of viewers, each viewer user profile in the plurality of viewer user profiles comprising one or more content permission 604. The one or more content permission may include access-based permission(s) (e.g., the ability to view a particular subset of broadcaster user profiles in the application), and/or content-based permissions (e.g. access to a maximum number of live video broadcasts in a specified time period).

Routine 600 may continue by providing, to a plurality of broadcaster client devices being communicably engaged with the application server via an Internet connection, a first user interface comprising interface elements for scheduling a live video broadcast 606. The interface elements may comprise elements for a broadcaster user to configure an online calendar, set a broadcast schedule, create a live video broadcast event, set a live video broadcast type (e.g. one-to-one or one-to-many), set a live video broadcast duration, set one or more rules or restrictions for the live video broadcast, and the like. Upon the broadcaster user configuring a plurality of parameters for the live video broadcast, routine 600 continues by providing, to a plurality of viewer client devices being communicably engaged with the application server via an Internet connection, a second user interface comprising interface elements for requesting to participate in the live video broadcast 608. Interface elements for requesting to participate in the live video broadcast may include an online calendar, online ticketing system, access request message to the broadcaster user or other application administrator, and/or other participation request communication.

Routine 600 continues by receiving, with the application server, a plurality of requests associated with the plurality of viewer user profiles to participate in the live video broadcast 610. As the application receives the plurality of requests associated with the plurality of viewer user profiles to participate in the live video broadcast, routine 600 creates, with the application server, an event reservation associated with the plurality of requests associated with the plurality of viewer user profiles to participate in the live video broadcast 612. As stated above, one or more permission steps may be optionally executed in advance of the event reservation being created by the application server.

When the broadcaster is ready to execute the live video broadcast, routine 600 continues by providing, with the application server, a third user interface comprising a live video broadcast module to the plurality of broadcaster client devices and the plurality of viewer client devices 614. The live video broadcast is executed via the live video broadcast module 616 between at least one broadcaster client device in the plurality of broadcaster client devices and at least one viewer client device in the plurality of viewer client devices. The application server may optionally track viewer statistics associated with the live video broadcast.

Routine 600 may continue by storing, with the application server, viewer statistics associated with the live video broadcast 618. Upon completion of the live video broadcast and storing of the viewer statistics, routine 600 may proceed by processing, with the application server, a payment transaction according to the viewer statistics. For example, and as discussed above, the payment transaction may comprise billing a user's credit card or applying a subscription credit against the viewer user's profile. For example, if the user subscription level comprising a total of four credits to participate in live video broadcasts in a one-month period, the application will accordingly update the user's profile to restrict the user's participation to three credits within the remaining subscription period. The payment transaction may also comprise a payment settlement associated with the broadcaster user profile. The payment transaction may be settled in real-time or at scheduled intervals (for example, bi-weekly). The broadcaster user may be compensated based on the number of viewers who viewed or participated in the live video broadcast. The compensation may also be determined by the type of viewer payment; for example, if the viewer paid $10 to participate in the broadcast, the broadcaster may be compensated $7. Alternatively, if the viewer used a subscription credit to participate in the broadcast, the broadcaster may be compensated a pro rata value of the subscription price against the subscription credit. For example, if the subscription price is $10 and entitles the user to 4 broadcast credits, the broadcaster may be compensated some percentage of $2.50 (e.g. $10/4 credits=$2.50/credit). The application may retain a predetermined profit margin (for example, 30%) and settle a transaction to the broadcaster user for the remaining amount of money on a per viewer per broadcast basis.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks, memory cards or sticks, random access memories (RAMS), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

Thus, the following claims are hereby incorporated into the Detailed Description, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A system for facilitating live online events comprising:
an event management application server being configured to execute instructions for a user management module, an event management module, and a plurality of application and business logic commands, the user management module operable to dynamically configure a plurality of viewer user profiles and a plurality of broadcaster user profiles, the event management module being operable to dynamically configure a plurality of live online events;
a database operably engaged with the event management application, the database being operable to store a plurality of event management and user management attributes;
a video server operably engaged with the event management application;
at least one broadcaster client device operable to communicate one or more inputs to the event management application and broadcast a live online event; and,
at least one viewer client device operable to communicate one or more inputs to the event management application and view the live online event via a web or mobile browser.

2. The system of claim 1 wherein the user management module further comprises a plurality of user parameters, the user parameters comprising a plurality of user preferences and one or more permissions for viewing the live online event.

3. The system of claim 1 wherein the event management module further comprises a payment module configured to calculate and remit a payment to a broadcaster user according to one or more participant parameters associated with the live online event.

4. The system of claim 2 wherein the plurality of user preferences comprises preferences for associating two or more broadcaster user profiles with a viewer user profile.

5. The system of claim 1 wherein the event management module further comprises a broadcaster user interface that includes interface elements for creating a live event and configuring a broadcaster calendar.

6. A computer-implemented method comprising:
creating, with an application server, a broadcaster user profile in a social network;
creating, with the application server, a viewer user profile in the social network, the viewer user profile comprising one or more profile parameters;
providing to a broadcaster client device, a first user interface to a broadcaster user associated with the broadcaster user profile, the first user interface comprising a first plurality of workflows comprising:
a workflow to connect a bank account with the application server to facilitate processing of a payment transaction associated with completion of a live video broadcast over the Internet;
a workflow to create a calendar listing for the live video broadcast in the application server; and,
a workflow to create a broadcaster schedule in the application server;
providing to a viewer client device, a second user interface to a viewer user associated with the viewer user profile comprising a first plurality of interface elements corresponding with a plurality of broadcaster user profiles and a second plurality of interface elements corresponding with a plurality of scheduled live video broadcasts;
creating, via the second user interface, at least one booking corresponding to at least one scheduled live video broadcast in the plurality of scheduled live video broadcasts;
storing, in an application database, the at least one booking and associating the at least one booking with the viewer user profile in the application database;
providing, with an email server operably engaged with the application server, a notification of the at least one booking;
providing, with the application server, a third user interface comprising a live video broadcast module to the broadcaster client device and the viewer client device;
executing, via the live video broadcast module, the scheduled live video broadcast associated with the booking;
creating, in the application database, an entry of the total viewer profiles participating in the scheduled live video broadcast; and,
executing, via the application server, a payment transaction associated with the broadcaster user profile.

7. The computer-implemented method of claim 6 further comprising updating, with the application server, the viewer user profile according to the one or more profile parameters, the one or more profile parameters comprising permissions for participation in the plurality of scheduled live video broadcasts.

8. The computer-implemented method of claim 6 further comprising providing a live video broadcast recommendation to the viewer user profile according to the one or more profile parameters.

9. The computer-implemented method of claim 6 wherein the live video broadcast is a one-to-one broadcast.

10. The computer-implemented method of claim 6 wherein the live video broadcast is a one-to-many broadcast.

11. A computer-implemented method comprising:
configuring, with an application server, a plurality of broadcaster user profiles associated with a plurality of broadcaster users;
configuring, with the application server, a plurality of viewer user profiles associated with a plurality of viewers, each viewer user profile in the plurality of viewer user profiles comprising one or more content permission;
providing, to a plurality of broadcaster client devices being communicably engaged with the application server via an Internet connection, a first user interface comprising interface elements for scheduling a live video broadcast;
providing, to a plurality of viewer client devices being communicably engaged with the application server via an Internet connection, a second user interface comprising interface elements for requesting to participate in the live video broadcast;
receiving, with the application server, a plurality of requests associated with the plurality of viewer user profiles to participate in the live video broadcast;
creating, with the application server, an event reservation associated with the plurality of requests associated with the plurality of viewer user profiles to participate in the live video broadcast;
providing, with the application server, a third user interface comprising a live video broadcast module to the plurality of broadcaster client devices and the plurality of viewer client devices;
executing, via the live video broadcast module, the live video broadcast;
storing, with the application server, viewer statistics associated with the live video broadcast;
processing, with the application server, a payment transaction according to the viewer statistics.

12. The computer-implemented method of claim 11 wherein the one or more content permission comprises a maximum number of live video broadcasts that the viewer user profile can access within a specified time frame.

13. The computer-implemented method of claim 11 further comprising providing a scheduled live video event broadcast recommendation to the viewer user profile in response to the viewer statistics.

14. The computer-implemented method of claim 11 further comprising providing a broadcaster recommendation to the viewer user profile in response to the viewer statistics.

15. The computer-implemented method of claim 11 further comprising providing a viewer user profile recommendation to the broadcaster user profile in response to the viewer users statistics.
